(19) United States
(12) Patent Application Publication
(10) Pub. No.: US 2013/0061466 A1
(43) Pub. Date: Mar. 14, 2013

(54) MULTI-RESPONSE VIBRATION DAMPER ASSEMBLY

(71) Applicants: Bryan Casenhiser, Twinsburg, OH (US); Darnell Johnson, Streetsboro, OH (US)

(72) Inventors: Bryan Casenhiser, Twinsburg, OH (US); Darnell Johnson, Streetsboro, OH (US)

(73) Assignee: PERFORMED LINE PRODUCTS COMPANY, Mayfield Village, OH (US)

(21) Appl. No.: 13/126,181

(22) PCT Filed: Aug. 20, 2009
(86) PCT No.: PCT/US09/54431

§ 371 Date: Sep. 28, 2012

(51) Int. Cl. H02G 7/14; H02G 1/02

(52) U.S. Cl. CPC H02G 7/14; H02G 1/02
USPC 29/825; 174/42; 29/428

(57) ABSTRACT

A damper assembly system that can provide for multiple frequency responses to control Aeolian vibration in EHV (Extra High Voltage) applications is disclosed. The damper assembly comprises an asymmetric design that enables two disparate frequency responses at either side of the clamp that attaches the damper to a suspended member or cable. Two additional frequency responses are enabled at an inlet point of each of the damper weights. The damper weights can have a rounded or egg-shape together with an inner cavity so as to control corona discharge in EHV applications. Additionally, the tuned weights can be of disparate mass as well as asymmetric distances from the clamp.

### BACKGROUND

In the utility industry, transmission lines are used to direct electrical energy from one location to another over various distances. A vibration damper is a device used for damping vibrations that often occur in suspended members, such as overhead power transmission lines. Most often, vibration dampers comprise a pair of weights joined by a stranded steel cable (commonly known as a ‘messenger cable’) and a clamp attached to the stranded cable at a location intermediate to the weights. The clamp enables the damper to attach to the suspended member or overhead power transmission cable.

The configuration of weights mounted on the ends of the messenger cable is specifically designed to resonate at frequencies determined to be appropriate for the vibration occurring in the transmission line cable. Conventional vibration dampers function by dissipating energy through flexing of the messenger cable plus the kinetic energy of the weights.

A Stockbridge damper is the most common type of damper used in the industry today. Essentially, a Stockbridge damper is a tuned mass damper that is used to suppress wind-induced vibrations on suspended cables, such as overhead power transmission lines. The damper is designed to dissipate the energy of oscillations in the main cable to an acceptable level thereby reducing possibility of damage to the cable and associated hardware.

It is known that wind can generate three major modes of oscillation in suspended cables. These three major modes are referred as “gallop,” “Aeolian vibration,” and “wake-induced vibration.” A “gallop” refers to motion having an amplitude measured in meters with a frequency range of about 0.08 to 3 hertz (Hz). “Aeolian vibration” has an amplitude that ranges from millimeters to centimeters with a frequency of 3 to 150 Hz. Finally, “wake-induced vibration” has an amplitude of centimeters with a frequency between about 0.15 to 10 Hz. The conventional Stockbridge-type damper targets oscillations due to Aeolian vibration. Traditional dampers are less effective outside this amplitude and frequency range.

As will be understood, a steady but moderate wind often induces a standing, or stationary, wave pattern on suspended cable consisting of several wavelengths per span. When this oscillation falls within the category of Aeolian vibration, it can cause damaging stress fatigue to the cable and associated hardware. This stress fatigue is a principal cause of failure of conductor strands. Thus, vibration dampers, such as Stockbridge-type dampers, are commonly used to dissipate the energy caused by Aeolian vibration.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

Wind induced line vibration is caused by low speed laminar wind flow, typically 2-15 miles per hour (MPH). This phenomenon is characterized by high frequency (e.g., approximately 3-150 hertz (Hz)) low amplitude motion (e.g., millimeters to centimeters) and can cause catastrophic damage to a conductor/cable and associated hardware over time. In order to alleviate and/or eliminate wind induced line vibration, Stockbridge-type dampers are often utilized. The innovation disclosed and claimed herein, in one aspect thereof, comprises a vibration damper assembly (and methodologies of using the same) capable for use on Extra High Voltage (EHV), e.g., in excess of 230 kilovolts (kV).

In aspects, the innovation exceeds the traditional Stockbridge two response performance by disclosing a multi-response design that effectively reduces vibration over a wider range of imposing frequencies. In aspects, this is accomplished by a design that has unequal messenger strand lengths (on either side of the clamp) which can further be enhanced by utilizing unequal damper weights.

Each of the weights can be tuned to match a specific range of conductor or cable impedances and line operating conditions to strive to achieve optimum performance. In order to enable operation at EHV levels, each of the weights employs a distinct geometry that incorporates a smooth outer rounded or egg-like shape. This smooth rounded shape eliminates the likelihood of corona discharge at voltages in excess of 230 kV.

In addition to the outer rounder shape, the innovation employs weights having a uniquely designed inner cavity which is capable of producing four frequency responses over a wider range of frequencies. The first two modes of vibration occur distal to the clamp for each weight. In aspects, these modes take effect at different frequencies due to the asymmetric messenger lengths and/or imbalanced weights.

The two remaining responses occur when each weight oscillates about its center of gravity at separate frequencies. The weights are constructed with a specific distribution of mass in the inner cavity to achieve the optimal center of gravity. The overall mass of the entire damper can therefore be significantly lighter than the traditional bell-shaped (e.g., Stockbridge-type) damper due to optimizing the performance. In aspects, the damper can be attached to a conductor using a traditional bolted or, alternatively, a “coat-hanger” or hook-type clamp. Still further, helical rods can be employed to secure connection upon a conductor (e.g., in coat-hanger type clamp applications). A cushion (e.g., elastomeric cushion) can optionally be placed between the clamp and the conductor as desired.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1A illustrates a perspective view of a damper assembly in accordance with an aspect of the innovation.

FIG. 1B illustrates a perspective view of a damper assembly in accordance with an alternative aspect of the innovation.

FIG. 2 illustrates a perspective view of an asymmetric damper assembly in accordance with an aspect of the innovation.

FIG. 3A illustrates a cross-sectional perspective view of a small damper weight showing an inner cavity in accordance with an aspect of the innovation.

FIG. 3B illustrates a cross-sectional perspective view of a small damper weight showing the inlet side of the weight in accordance with an aspect of the innovation.

FIG. 4A illustrates a cross-sectional perspective view of a large damper weight showing an inner cavity in accordance with an aspect of the innovation.

FIG. 4B illustrates a cross-sectional perspective view of a large damper weight showing the inlet side of the weight in accordance with an aspect of the innovation.

FIG. 5 illustrates a perspective view of an example asymmetric damper assembly in accordance with an aspect of the innovation.

FIG. 6 illustrates a cross-sectional perspective view of an example small damper weight showing an inner cavity in accordance with an aspect of the innovation.

FIG. 7 illustrates a cross-sectional perspective view of an example large damper weight showing an inner cavity in accordance with an aspect of the innovation.

FIG. 8 illustrates an example methodology of assembly and/or use of a damper assembly in accordance with aspects of the innovation.

FIG. 9 illustrates an example methodology of assembly and/or use of a damper assembly in accordance with aspects of the innovation.

FIG. 10 illustrates an example methodology of assembly and/or use of a damper assembly in accordance with aspects of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

Aeolian vibration is a high frequency, low amplitude motion most often caused by smooth laminar winds passing across the transmission line. When conductors or cables are exposed to this wind, a phenomenon known as “eddy” or “vortex shedding” produces vibration in the line. Aeolian vibration can cause hardware breakdown, conductor fatigue, abrasion, and eventually, conductor failure. Vibration dampers are commonly used to control, minimize or eliminate the effects of Aeolian vibration. Conventionally, Stockbridge-type dampers used are limited to two (2) frequency responses.

As will be understood, the innovation improves on the decades-old technology of the dual-response Stockbridge-type damper. Because of weight construction, the original Stockbridge damper was only effective at reducing vibration for two (2) frequencies of conductor vibration. In contrast, the innovation discloses a multi-response design that effectively reduces vibration over a wider range of imposing frequencies than the conventional Stockbridge-type dampers. As will be described in greater detail below, this greater frequency coverage is accomplished by a unique weight distribution and design by which weight sizes and messenger strand lengths can be tuned and matched to specific conductor/cable impedance and line operating conditions to achieve optimum performance. It will be understood upon a review of the discussion that follows, the innovation's unique rounded or egg-shaped weight design enables the damper to be employed in extra high voltage (EHV) applications above 230 kilovolts (kV).

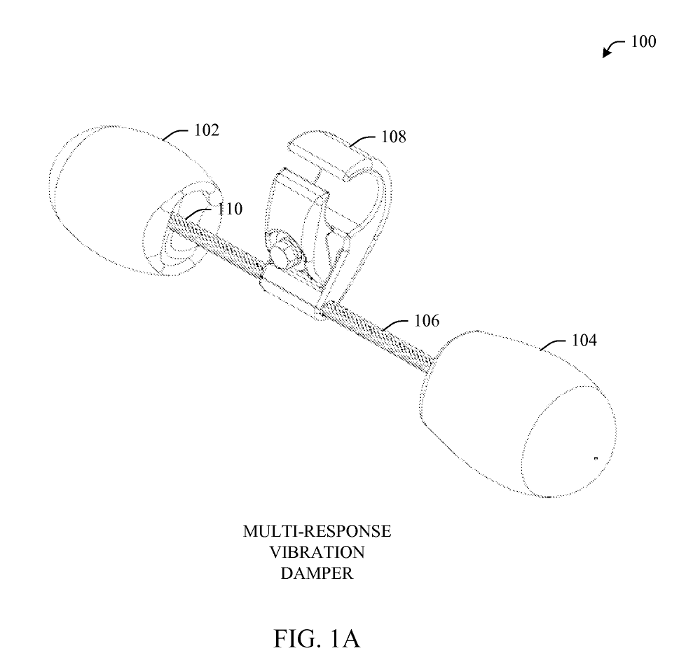

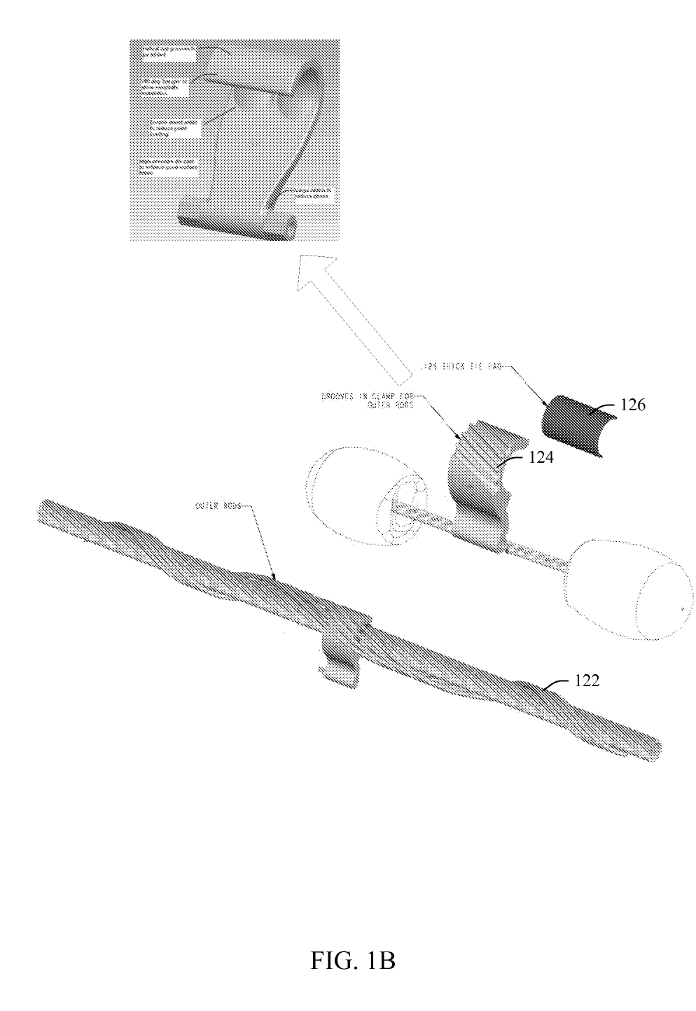

Referring initially to FIG. 1A, an example perspective view of a vibration damper assembly 100 in accordance with aspects of the innovation is shown. Generally, the damper assembly 100 can include two weights (102, 104) fixedly joined together by way of a resilient element 106, such as a stranded cable or “messenger.” An attachment means (e.g., clamp) 108 can be employed to connect the messenger 106 to a suspended cable (not shown) in order to minimize vibration (e.g., Aeolian vibration). While a specific clamp 108 is shown in FIG. 1A, it is to be understood that alternative attachment means or clamping mechanisms can be employed without departing from the spirit and/or scope of this specification and claims appended hereto. For example, the clamp 108 can be designed to employ smooth or rounded edges. This design feature can assist in controlling corona discharge in high voltage applications, such as EHV environments. Yet another example attachment means is illustrated in FIG. 1B as described below.

As illustrated in FIG. 1A, each of the weights (102, 104) can be substantially egg-shaped or rounded. This unique design enables the damper assembly 100 to be conducive to EHV applications. In aspects, the weights can be manufactured of galvanized modular iron and can be positioned at and fixedly attached at each end of a messenger strand. It will be understood that, in addition to providing freedom of movement, the feature of positioning the weights such that they do not touch the messenger at the point of entry (110), reduces or otherwise eliminates possibility of corrosion.

In operation, the weights can be of equal or unequal heaviness or mass as deemed favorable by application. Similarly, the clamp 108 can be disposed at a midpoint or offset location of the messenger as deemed appropriate by a particular application. In other words, asymmetric geometry can be accomplished by either, or both, unequal weights and/or offset attachment means placement upon the messenger.

As described above, the clamp 108 can be designed in such a manner so as to control corona discharge in EHV applications. In some applications, the clamp can be a contoured clamp manufactured of aluminum alloy extrusions which, as will be understood, can offer a precise fit to evenly capture the conductor (not shown). Additionally, the profile of the clamp 108 can be configured to hang from the conductor or cable (not shown) during installation in accordance with regulations, e.g., IEC (International Electrotechnical Commission) standards. In this manner, an installer's hands are free to tighten the clamp or apply helical rods as appropriate.

In aspects, the messenger 106 is a stranded cable constructed of galvanized steel. It will be understood that this material and construction can provide enhanced absorption of vibration energy. In other aspects, the messenger 106 can also be coated with a mischmetal coating or a bezinal coating rather than galvanization. It is to be understood that most any suitable material is contemplated and intended to fall within the scope of the hereto-appended claims. Movement of the damper weights 102, 104 produces bending of the messenger 106 which causes the individual wires of the messenger 106 to rub together, thus dissipating energy. Each of the weights (102, 104) can be attached to the messenger 106 utilizing a collet-, crimp- or staking ball-type attachment. For example, most any attachment means which meets pull-off strength requirements in accordance with IEC standards without substantially modifying properties of adjoining messenger can be employed.

FIG. 1B illustrates an alternative attachment means to that shown in FIG. 1A supra. While specific attachment means (and installations thereof) are shown and described in connection with the innovation, it is to be understood that these means (e.g., clamps) are not intended to limit the scope of the specification in any manner. As illustrated in FIG. 1B, rather than employing a bolted clamp as shown in FIG. 1A, outer or helical rods 122 can be used to secure the clamp to a conductor.

In a specific example, grooves 124 within the hook or “hanger-shaped” clamp can be provided to secure the outer rods within the clamp. Additionally, insert 126 can be disposed between the clamp 124 and a conductor. In one aspect, insert 126 can be a secure elastomer insert. As described above, it is to be understood that the weights can be attached using most any method including, but not limited to collet, staking ball, crimp or the like.

The clamp design illustrated in FIG. 1B can provide a one handed fit, e.g., during installation, the clamp can suspend from a conductor without rods, similar to a “coat-hanger.” In addition to the helical rod grooves, the clamp can include a 180° ‘hanger’ that assists with easy and safe installation upon a conductor. Still further, the clamp can be manufactured of a high pressure die cast that achieves EHV sufficient surface finish and includes a double insert width that reduces point loading. It is to be understood and appreciated that various size inserts can be used to specifically suit the conductor diameter.

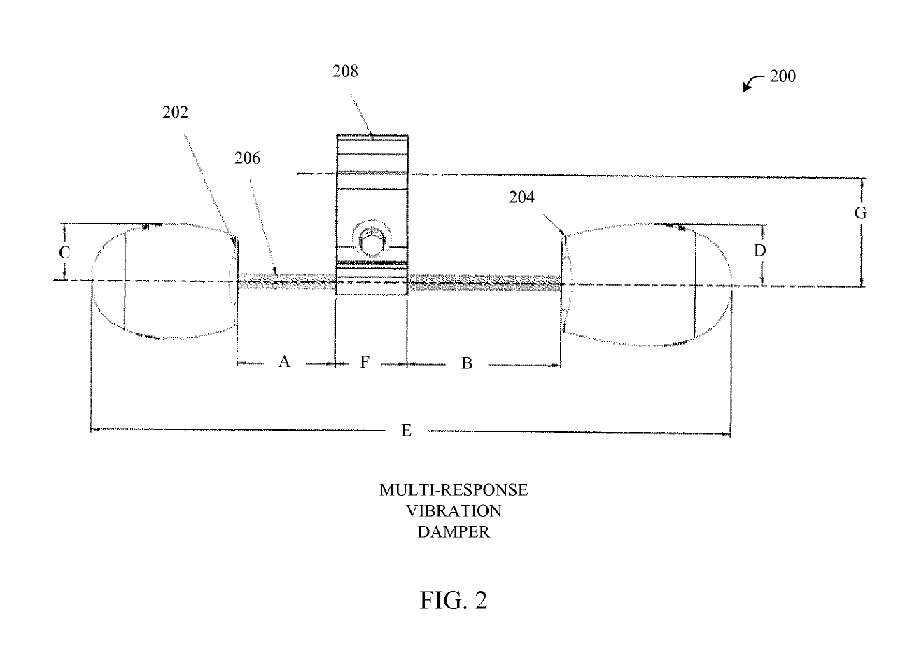

Referring now to FIG. 2, an alternative perspective view of a damper assembly 200 in accordance with an aspect of the innovation is shown. In many ways, the innovation improves upon the proven theory of the traditional Stockbridge-type damper. The innovation converts wind induced energy from the conductor (not shown) into heat generated by weights (202, 204) oscillating on short pieces of messenger cable 206. One drawback of the original Stockbridge-type dampers is that they are only effective at reducing vibration for two (2) frequencies of conductor vibration.

By contrast, the damper assembly (e.g., 100, 200) exceeds the two (2) response performance with a multi-response design that effectively reduces vibration over a wider range of imposing frequencies. In aspects, as shown in FIG. 2, this can be accomplished by an asymmetric design that incorporates an offset clamp along the messenger strand enhanced with unequal weights. Effectively, the weight sizes and messenger strand lengths can be matched to specific conductor/cable impedance and line operating conditions that achieve optimum performance.

It is to be understood that the asymmetric geometry can be accomplished in at least three manners. In a first aspect, asymmetry can be enabled by locating a clamp 208 at an offset location upon the messenger 206. In a second aspect, asymmetry can be effected by utilizing weights 202, 204 of unequal mass. Still further, a third asymmetric aspect can employ both and offset clamp together with unequal mass of the weights 202, 204. It will be understood that the unique design of the weights enhances the frequency vibration coverage by enabling oscillation about the center of gravity of each of the damper weights 202, 204.

As illustrated in FIG. 2, in one example, weight 202 can be disposed at a distance “A” from a clamp 208 while a second weight 204 can be disposed at a distance “B” from the clamp 208. In other words, clamp 208 can be positioned between weights of unequal mass in an asymmetric manner (e.g., “A” and “B” are not equal distances). As will be appreciated, the example of FIG. 2 illustrates weights of different sizes (202, 204). This difference in visual size of the weights (202, 204) is further illustrated by the difference in centerline dimensions “C” and “D” of each weight. Accordingly, in this example, the mass or heaviness is different for each weight.

It is to be understood that the aspect illustrated in FIG. 2 is to provide perspective and understanding of the asymmetric design of the subject apparatus. It is therefore to be understood that alternative designs, weights, lengths, positions or the like can be employed without departing from the spirit and/or scope of the innovation and claims appended hereto.

It is further to be understood that the clamp 208 can be positioned off-center of distance “E” as appropriate or desired in accordance with particular design Characteristics. “F” designates the width of the clamp 208 and defines an area by which the clamp 208 grasps the messenger 206. Additionally, as shown in the example of FIG. 2, this distance, “F,” defines the area by which the clamp 208 grasps a suspended structure, e.g., overhead transmission cable. Distance “G” defines an example mounting distance defined by a centerline of the messenger to the centerline of a conductor (not shown) upon which the damper assembly can be mounted. As stated supra, it is to be understood that alternative designs of clamps (or attachment means) can be employed without departing from the spirit and/or scope of the innovation and claims appended hereto. By way of example, the clamp 208 can be rounded similar to the weights 202, 204 so as control or manage corona discharge in EHV applications.

While specific measurements, weights, materials, shapes and configurations may described infra, it is to be understood that these examples are provided to add perspective to the innovation and are not intended to limit the scope of this disclosure and claims appended hereto. Accordingly, it is to be understood that alternative embodiments exist and are to be included within the scope of this disclosure. For example, alternative, sizes, materials, as well as configurations may be appropriate for alternative applications. These alternatives are to be included within the spirit and scope of this disclosure and claims appended hereto.

With reference again to FIG. 2, a perspective view of an example damper assembly 200 is shown that is capable of four-responses to wind induced line vibration, e.g., vibration characterized by high frequency, low amplitude motion, (e.g., Aeolian vibration). As illustrated, the damper assembly 200 comprises a pair of damper weights 202, 204 joined by a stranded steel messenger cable 206 and a clamp 208 attached to the messenger cable 206 at a location intermediate the damper weights 202, 204 for attachment to an overhead power transmission conductor/cable (not shown). As illustrated, each of the damper weights is specifically designed in a rounded or egg-shaped configuration so as to enable use in EHV applications. Additionally, each of the weights (202, 204) can have specifically tuned individual weights. In other words, one weight (202, 204) can be heavier in mass and/or larger in size that the other weight (202, 204). It will be understood that this disparity in mass enables a wider response frequency range.

As shown in FIG. 2, the asymmetric weight and/or clamp placement design can provide for up to four (4) resonant response frequencies, e.g., two for the small weight (202) and two for the large weight (204). This multi- or four-response protection can provide for more effective protection than standard or conventional Stockbridge-type dampers. In aspects, the weights (202, 204) are manufactured from a galvanized ductile iron casting. In operation, the small weight 202 provides damping at higher frequencies while the larger weight 204 provides damping protection at lower frequencies.

In summary, the EHV dampers (100, 200) can respond to Aeolian vibration which is wind induced line vibration that is usually characterized by high frequency, low amplitude motion. The damper 200 of FIG. 2 having small 202 and large 204 weights can achieve greater power dissipation and frequency response performance than “symmetrical weight” Stockbridge damper designs. It will be appreciated that wider frequency coverage translates into better protection as energy is more effectively dissipated over the entire range of conductor/cable frequencies. Additionally, the rounded or egg-like shape of the weights (102, 104, 202, 204) enable the damper to be utilized in EHV applications while controlling corona discharge.

Similarly, the placement or arrangement of the clamp 208 upon the messenger 206 and heaviness (or mass) of each of the weights (202, 204) can be specifically selected for particular applications. It will be appreciated and understood that dampers (e.g., 100, 200) have specific performance characteristics that require strategic placement on the line to counter potential damage to the line system. Placement (and damper design) should be carefully selected so as to provide adequate vibration protection. It will be appreciated that, for example, longer spans that require additional protection may require more dampers placed midspan.

In many cases, extremely long spans extend over rivers or valleys and require additional protection due to high laminar wind speeds. Effectively, the configuration of damper weights 202, 204 mounted on the ends of the messenger cable 206 as well as the position upon a span is designed to resonate at frequencies determined to be appropriate for the vibration occurring in the EHV transmission line conductor/cable. The degree of protection required on a specific line depends upon a number of factors including, but not limited to, line design, local climate, tension, exposure to wind flow, and line vibration history in the area.

The recommended number of dampers per span most often depends on the amount of wind energy exposure and the conductor/cable characteristics. Self-damping is a conductor or cable characteristic attributed to component material and construction—for example, the individual metal strands that make up a conductor can move relative to one-another and dissipate energy. Increasing line tension, however, will decrease self-dampening as the individual strands begin to lock together. Thus, placement of dampers can be critical to protection from damaging vibration.

The transmission line conductor or suspended cable (not shown) is typically an aluminum-based conductor such as aluminum conductor steel reinforced (ACSR) conductors, all-aluminum conductor (AAC), all-aluminum alloy conductors (AAAC), aluminum conductor alloy reinforced (ACAR) conductors, etc. However, other conductors/cables can be used. It is thus to be understood that most any suitable conductors/cables are contemplated and intended to fall under the scope of this disclosure.

Typically, the damper assembly 200 is clamped onto the conductor via a clamp 208. The clamp (108, 208) can have an extruded hook shaped profile (as shown in FIG. 1) which can suspend on the conductor. The clamp 108, 208 can include a keeper which tightens and secures the conductor. However, the clamp 108, 208 can also be cast, forged or injection molded. Additionally, to control or eliminate corona discharge in EHV applications, the clamp can be designed in a rounded manner to enable use in EHV applications. Alternatively, the edges of the clamp can be manufactured in such a way so as to control corona discharge, for example, sharp edges can be rounded.

Although most often similar in shape, damper weights can vary in size, weight and even shape depending on a particular application or desired performance. However, as is to be understood, in accordance with EHV applications, the weights 202, 204 can have a substantially rounded- or egg-shape so as to manage, control or otherwise eliminate corona discharge in EHV environments/applications. It will be understood that, as conductors/cables increase in size, the conductors tend to vibrate at lower frequencies. In the asymmetric design as shown in FIG. 2, the large damper weight (204) can provide damping at lower frequencies while the small damper weight (202) can provide damping at higher frequencies. Typically, the damper weights 202, 204 are made of galvanized ductile iron casting, but can be manufactured of most any suitable material known in the art.

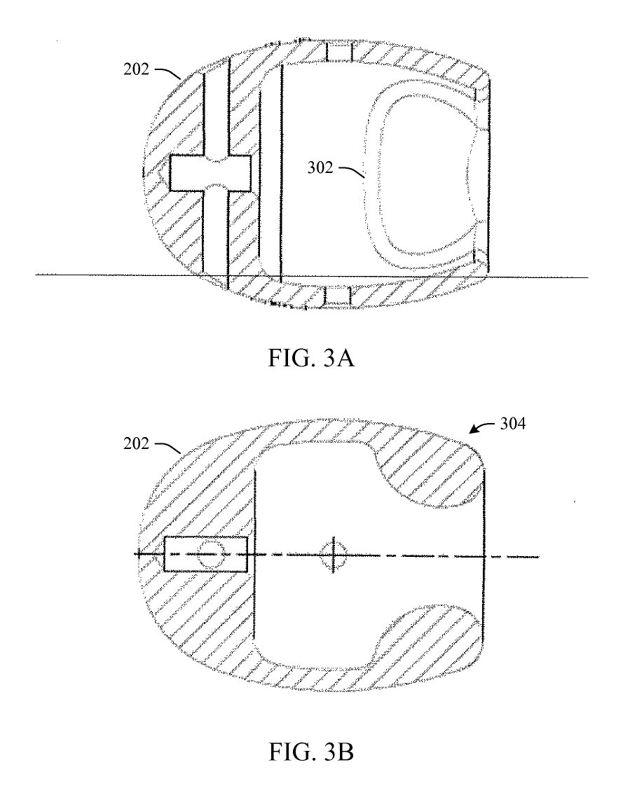

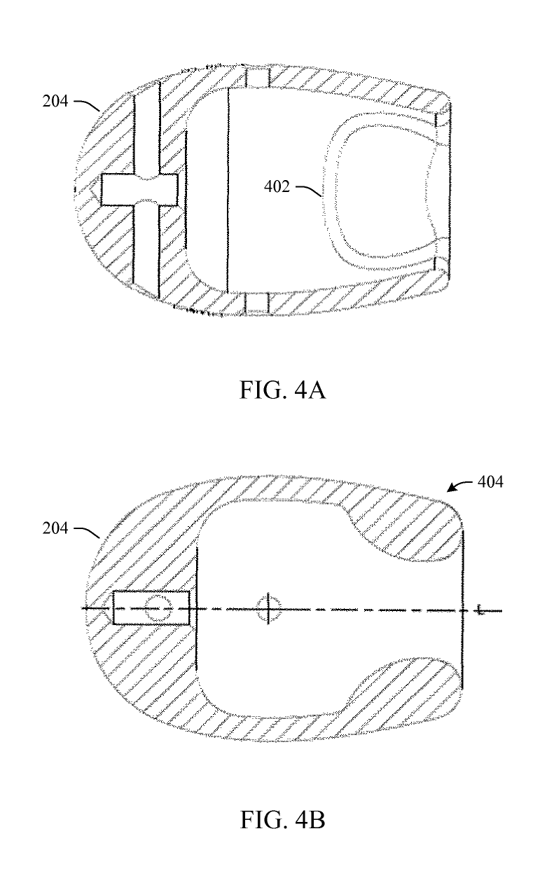

Turning now to FIGS. 3A-B, top and side cross-sectional views of a smaller damper weight 202 are shown respectively. While specific shapes are shown, it is to be understood that alternative designs can be employed which exhibit suitable variations of the designs shown in FIGS. 3 A-B. These alternative shapes and configurations are to be included within the scope of the disclosure and claims appended hereto. It is to be understood that, with the exception of heaviness or mass, the general design and manufacture of the small weight of FIGS. 3A-B is substantially similar to that of the larger weight as shown in FIGS. 4A-B.

Referring now to FIGS. 3A-B, an example cross-section of a small weight is shown. As described above, in the asymmetric design (e.g., different sized weights and/or variable weight distance about the clamp), the innovation's damper design is capable of four (4) vibration responses. In other words, the innovation enables a damper design that is capable of addressing a wider range of frequency vibration by utilizing four (4) points of dampening response. The first two (2) responses are about the clamp on either side. The second two (2) responses are at (or about) the point in which the messenger enters (or connects to) each weight (202, 204). It will be understood that, disparate weight sizes together with unequal messenger lengths from the clamp to each weight (202, 204) enable the damper to be responsive to at least four (4) frequencies of vibration. Thus, the innovation enables broader frequency coverage in EHV applications than conventional dampening mechanisms.

As illustrated in FIGS. 3A-B, the outer shell of the weight 202 is substantially rounded. It will be understood that the substantially rounded shape enables the weights to be employed in EHV environments and applications. As shown, the example weight 202 has an egg-like shape that controls corona in environments greater than 230 Kv (e.g., EHV applications at 500 Kv). As shown in FIG. 3A, a skirt or inner cavity 302 is employed to effectively create a full- or near full-round structure that enables corona protection and enhanced performance at EHV.

In addition to the full-round (or substantially full-round) functionality of the skirt 302, the weight 202 can also include a mass distribution 304 toward the front (e.g., messenger inlet) of the weight 202. It will be appreciated that these features can enable corona management performance and vibration dampening properties in EHV applications due to enhancement to the weights' distribution and center of gravity. In operation, the weight is capable of oscillating about its center of gravity thereby enhancing dampening response.

As described with regard to FIGS. 3A-B, FIGS. 4A-B illustrate a large weight 204 that can be constructed in the same or similar manner as that described above. For example, a skirt 402 (inner cavity) and mass distribution 404 toward the messenger inlet side of the weight can enhance operation of the damper in EHV applications. While specific configurations are shown, it is to be understood that alternative aspects can exist that employ an asymmetric weighted damper for use in EHV applications. These alternative arrangements and designs are to be included within the spirit and scope of this disclosure and claims appended hereto.

In summary, it will be appreciated that wind induced line vibration is often caused by low speed laminar wind flow, typically between two (2) and fifteen (15) miles per hour. This phenomenon is characterized by high frequency low amplitude motion and can cause catastrophic damage to the conductor/cable over time. In order to eliminate wind induced line vibration, dampers are utilized. The asymmetrically weighted dampers exceed the traditional two (2) response performance with a multi-response design that effectively reduces vibration over a wider range of imposing frequencies.

This multi-response functionality is accomplished by a design that can have unequal messenger strand lengths enhanced with unequal weights as shown in FIG. 2 supra. In other words, a clamp can be placed in an offset position intermediate to the damper weights thereby created unequal messenger strand lengths. As will be understood, the weights can be engineered and tuned to match a specific range of conductor/cable impedances and line operating conditions that achieve optimum performance. The distinct geometry of the EHV weights (102, 202, 104, 204) incorporates a smooth outer egg-like or rounded shape that alleviates and/or eliminates the likelihood of corona discharge.

Generally, a traditional bell-shaped weight consists of a spherical body section with a tubular skirt extending therefrom. The traditional bell-shaped damper only warrants two responses for reducing Aeolian vibration. The uniquely designed inner cavity (302, 402) of the EHV weight (FIGS. 3A-B, 4A-B) is capable of producing four frequency responses over a wider range of frequencies. The first two modes of vibration occur distal to the clamp for each weight. In operation, these modes take effect at different frequencies due to the asymmetric messenger lengths and/or imbalanced weights.

The two remaining responses occur when each weight oscillates about its center of gravity at separate frequencies. The weights are constructed with a specific distribution of mass in the inner cavity to achieve the optimal center of gravity. The overall mass of the entire damper can therefore be significantly lighter than the traditional bell-shaped damper due to optimizing the performance.

In addition to the system or apparatus described and claimed herein, it is to be appreciated that both, the method of manufacture as well as the method of using a damper in accordance with this disclosure is contemplated and intended to be included within the scope of this disclosure. For example, methods of manufacturing damper weights such as those illustrated in FIGS. 3A, 3B, 4A and 4B are to be included within the spirit and scope of this disclosure. For instance, methods of manufacturing EHV-rated, egg- or rounded-shaped weights that are capable of oscillating about their center of gravity are to be included within the scope of this disclosure. Similarly, methods of assembly of dampers in accordance with the description are to be considered a part of this specification. Still further, methods of use, installation, or other application of dampers in accordance with this specification are to be considered within the scope provided herein.

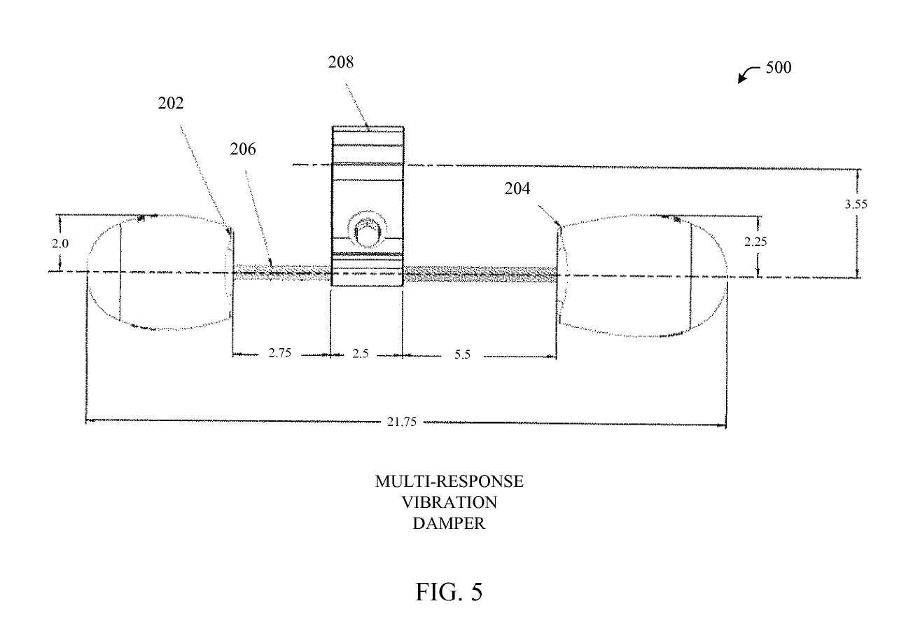

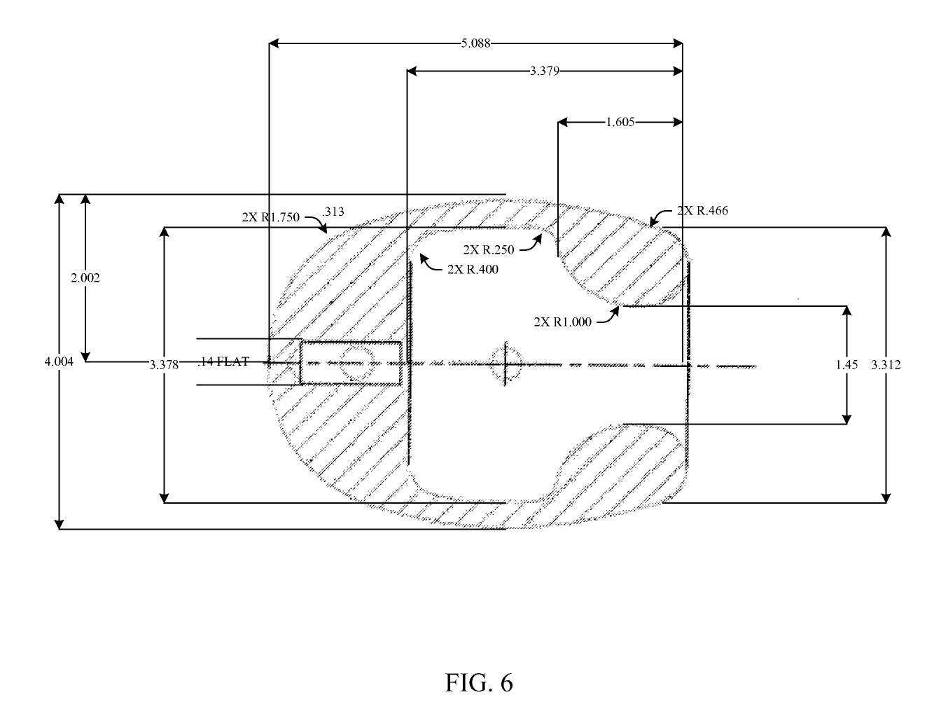

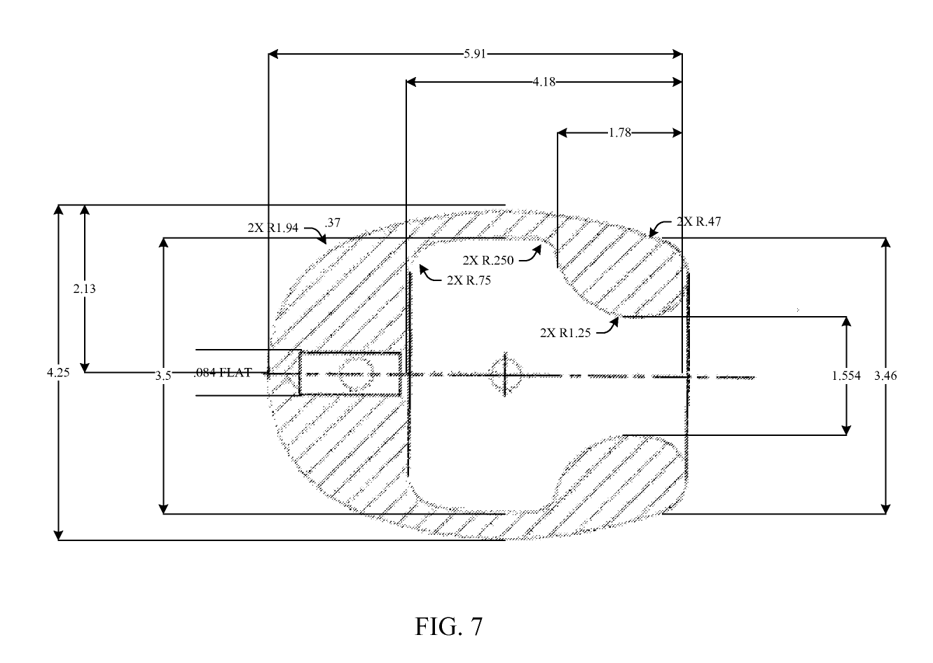

FIGS. 5-7 illustrate an example asymmetric damper assembly, small damper weight and large damper weight respectively. While specific dimensions (in inches) are shown, it is to be understood that these dimensions are exemplary and that alternatives exist without departing from the spirit and/or scope of the innovation and claims appended hereto. These alternatives are to be included within the scope of this disclosure and claims. It will be appreciated that the dimensions can vary, for example, based upon specific application and/or desired performance characteristics. Those skilled in the art are able to reconfigure the assembly and/or weights based upon the information included herein.

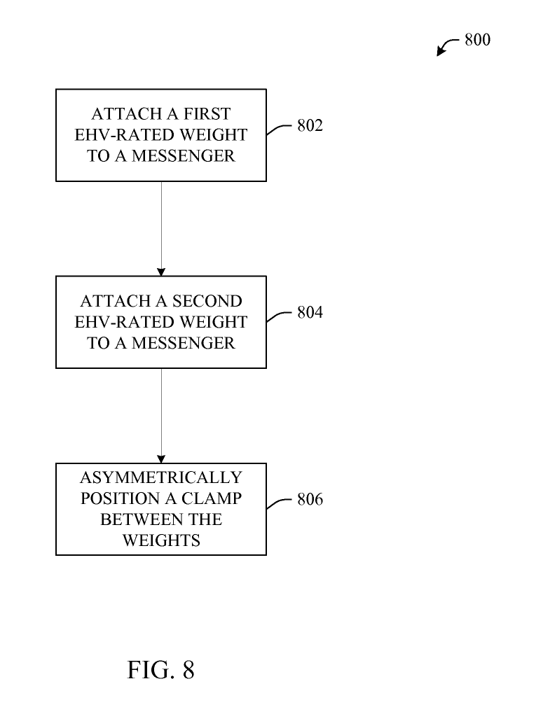

Referring now to FIGS. 8-10, illustrated are example methodologies 800, 900 and 1000 respectively that show procedures of assembly and/or use of a damper assembly in accordance with aspects of the innovation. While, for purposes of simplicity of explanation, the methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Referring initially to FIG. 8, a process of manufacturing or assembling a multi-response EHV-rated damper assembly is shown. At 802, a first EHV-rated damper weight is fixedly attached to one end of a messenger. As described above, the weight can be substantially egg-shaped to enable use in EHV-rated applications. Similarly, the messenger can be a stranded steel cable. The weight can be affixed in most any manner, including, but not limited to, crimping, use of a collett as well as staking ball.

At 804, a second EHV-rated damper weight can be fixedly attached to the opposite end of the messenger. Similar to the first weight, the means of attachment can be any means known in the art. In this example, the second weight can have the same or substantially similar weight as the first damper weight. At 806, a clamp can be asymmetrically positioned between the damper weights upon the messenger. It will be appreciated that asymmetric positioning of the clamp between the weights enables multi-response to vibration frequencies as described supra.

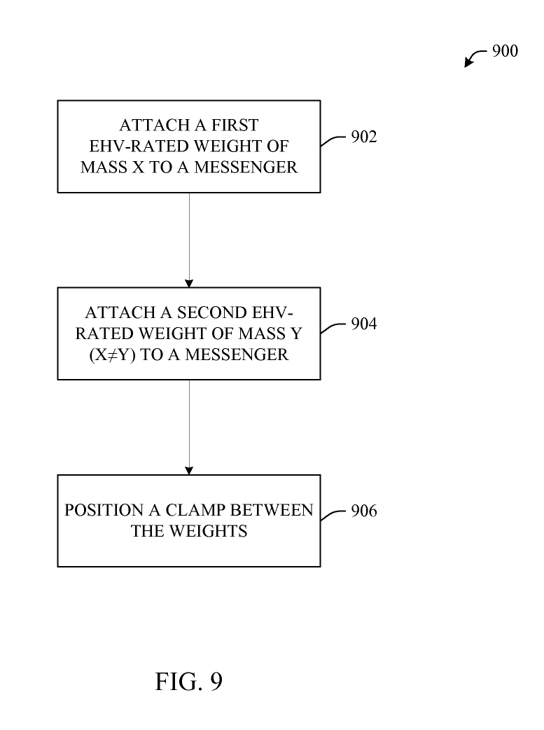

In FIG. 9, a similar methodology is shown. However, in accordance with the aspect of FIG. 9, at 902, a first EHV-rated weight has a mass X. At 904, a second EHV-rated weight having a mass Y, which is not equal to mass X, is attached to the other end of the messenger, opposite the first weight. At 906, a clamp is positioned between the weights. It will be understood that the clamp enables the damper assembly to be attached to a cable under tension, e.g., overhead transmission wire.

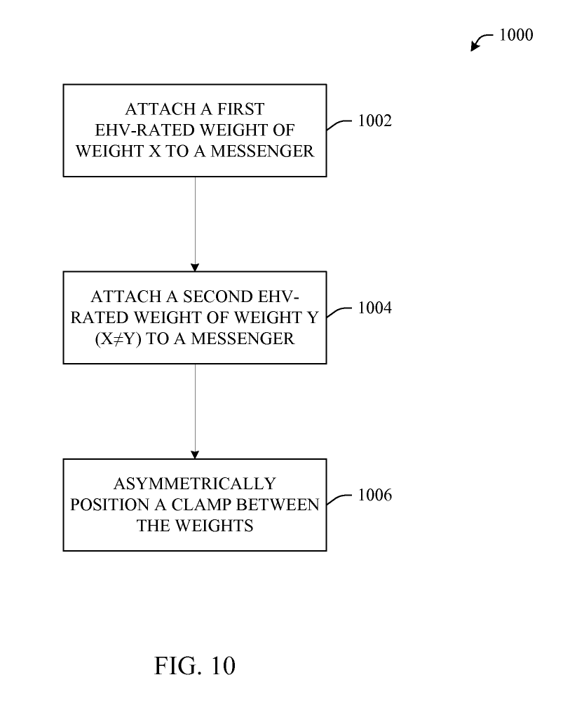

In FIG. 10, yet another similar methodology is shown. However, in accordance with the aspect of FIG. 10, at 1002, a first EHV-rated weight has a mass X. At 1004, a second EHV-rated weight having a mass Y, which is not equal to mass X, is affixed to the other end of the messenger. At 1006, a clamp is asymmetrically positioned between the weights. It will be understood that the clamp enables the damper assembly to be attached to a cable under tension, e.g., overhead transmission wire.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An apparatus that suppresses wind-induced vibrations on a cable, comprising:
a messenger having a first and second termination end;
a first weight fixedly attached to the first termination end;
a second weight fixedly attached to the second termination end; and
an attachment means asymmetrically positioned between the first and second weights, wherein the attachment means connects the apparatus to the cable and enables the apparatus to responds to at least four disparate resonant frequencies.

2. The apparatus of claim 1, wherein the first weight and the second weight are rated for applications upon suspended transmission lines in excess of 230 kilovolts (Kv).

3. The apparatus of claim 1, wherein the first weight has a first mass and wherein the second weight has a greater mass than the first mass.

4. The apparatus of claim 1, the first weight and the second weight comprise a substantially rounded outer shell having an inlet portion that accepts an end of the messenger; wherein the substantially rounded outer shell controls corona discharge in an Extra High Voltage (EHV) application.

5. The apparatus of claim 4, at least one of the first weight or the second weight comprise a mass distribution that enables oscillation about a center of gravity of about the at least one of the first weight or the second weight, wherein the oscillation enables response to vibration frequency.

6. The apparatus of claim 1, wherein the attachment means comprises a “hanger-shaped” apparatus having a plurality of grooves on the outward facing portion of the “hanger-shaped” apparatus, wherein the grooves retain a plurality of helical windings that secure the apparatus to the cable.

7. The apparatus of claim 6, further comprising an insert that cushions the connection between the attachment means and the cable.

8. The apparatus of claim 7, wherein the insert is an elastomeric insert.

9. The apparatus of claim 1, wherein two of the at least four disparate frequency responses occur when vibration is distal to the attachment means for each of the first weight and the second weight.

10. The apparatus of claim 9, wherein two of the at least four disparate frequency responses occur upon oscillation of at least the first weight or the second weight about its center of gravity.

11. The apparatus of claim 1, wherein the messenger is a stranded cable messenger.

12. The apparatus of claim 11, wherein the first weight and the second weight are attached to the messenger using a crimp- or collet-type attachment means.

13. The apparatus of claim 11, wherein the first weight and the second weight are attached to the messenger using a staking ball attachment means.

14. A dampening system, comprising:
a messenger cable having a fixed length;
a first substantially egg-shaped weight attached to a first end of the messenger cable, wherein the first substantially egg-shaped weight oscillates about its center of gravity; and
a second substantially egg-shaped weight having a mass greater than the first substantially egg-shaped weight and attached to a second end of the messenger cable, wherein the second substantially egg-shaped weight oscillates about its center of gravity.

15. The dampening system of claim 14, further comprising a clamp positioned asymmetrically between the first and second substantially egg-shaped weights, wherein the dampening system is capable of at least four response frequencies.

16. The damping system of claim 14, wherein the first and second substantially egg-shaped weights are EHV rated to control corona discharge.

17. The dampening system of claim 14, wherein each of the first and second substantially egg-shaped weights comprises an inner cavity having a skirt that provides for EHV corona discharge control.

18. A method of configuring a damper assembly, comprising:
attaching a first EHV-rated weight to one end of a messenger;
attaching a second EHV-rated weight to an opposite end of the messenger; and
asymmetrically positioning a clamp between the first weight and the second weight upon the messenger, wherein the clamp enables attachment to a cable under tension, and wherein the damper assembly facilitates response to a plurality of frequencies of vibration associated with the cable under tension.

19. The method of claim 18, wherein the first weight and the second weight have unequal masses.

20. The method of claim 18, further comprising wrapping a plurality of helical windings about the clamp, wherein the helical windings secure the clamp to the cable under tension.
